(19) United States
(12) Patent Application Publication
(10) Pub. No.: US 2011/0202445 A1
(43) Pub. Date: Aug. 18, 2011

(54) Method and System to raise capital for single product entertainment media companies

(76) Inventor: Adam Torres, Piermont, NY (US)

(21) Appl. No.: 12/943,003

(22) Filed: Nov. 10, 2010

Related U.S. Application Data
(60) Provisional application No. 61/259,644, filed on Nov. 10, 2009.

(51) Int. Cl. G06Q 40/00

(52) U.S. Cl. 705/37; 705/35

(57) ABSTRACT

A method and system for single product entertainment media corporations to develop initial public offerings (IPO) that are listed on an alternative trading system (ATS) and are bought sold and traded through the use of electronic communication networks (ECN) and other digital devices such as computers and smart phones. As well as having an option to create initial public offerings that take into account multiple iterations of the same intellectual property such as film sequels, television series or video game upgrades.

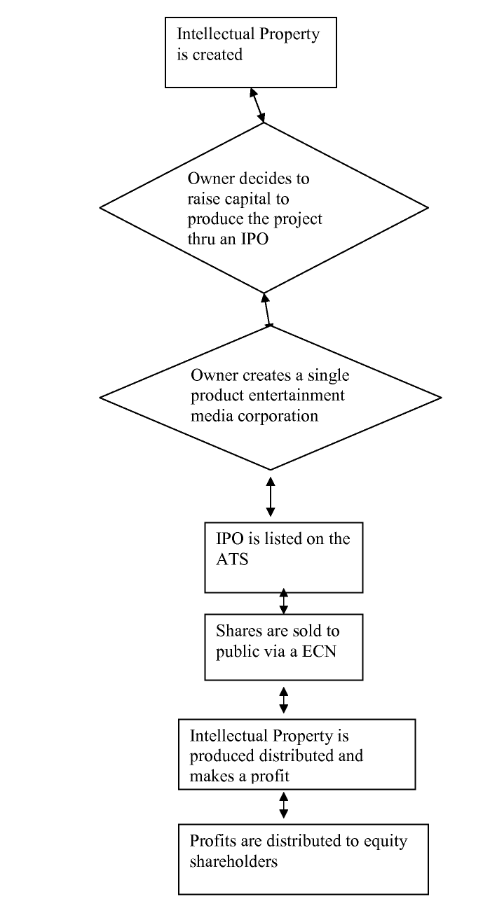

### CROSS-REFERENCE TO RELATED APPLICATIONS

This Application claims benefit of Provisional patent application serial number 61259644, filed Nov. 10, 2009 by the present inventor.

### FEDERALLY SPONSORED RESEARCH

Not Applicable

### SEQUENCE LISTING OR PROGRAM

Not Applicable

### BACKGROUND

1. Field

This application relates to entertainment media production and more specifically, how to finance the production and distribution of single product entertainment media properties.

2. Prior Art

Any discussion of the prior art throughout the specification should in no way be considered as an admission that such prior art is widely known or forms the part of common general knowledge.

In accountancy, Hollywood accounting is the practice of distributing the money earned by a large project to corporate entities which, though legally distinct from the one responsible for the project itself, are actually owned by the same people. This substantially reduces the profit of the project proper, sometimes eliminating it altogether. The effect of this practice is to reduce the amount which the corporation must pay in royalties or other profit-sharing agreements. Hollywood Accounting is not accepted by Generally Accepted Accounting Principles (GAAP) a term used to refer to the standard framework of guidelines for financial accounting used in any given jurisdiction which are generally known as Accounting Standards. GAAP includes the standards, conventions, and rules accountants follow in recording and summarizing transactions, and in the preparation of financial statements.

Hollywood accounting gets its name from the alleged frequent practice of it in the entertainment industry—that is, in the movie studios of Hollywood. Stereotypically, the creators of material which is adapted into screenplays fall victim to Hollywood accounting.

Due to Hollywood accounting, it has been estimated that only about 5% of movies officially show a net profit, and the “losers” include such blockbuster films as Rain Man, Forest Gump, Who Framed Rodger Rabbit, and Batman, which all took in huge amounts in box office and video sales.

Because of this, net points are sometimes referred to as “monkey points,” a term attributed to Eddie Murphy, who is said to have also stated that only a fool would accept net points in his or her contract.

All of this shows why so many big-name actors insist on “gross points” (a percentage of some definition of gross revenue) rather than net profit participation.

The saying in Hollywood is “a percentage of the net is a percentage of nothing ” This practice reduces the likelihood of a project showing a profit, as a production company will claim a portion of the reported box-office revenue was diverted directly to gross point participants.

Winston Groom's price for the screenplay rights to his novel Forrest Gump included a share of the profits; however, due to Hollywood accounting, the film's commercial success was converted into a net loss, and Groom received nothing. That being so he has refused to sell the screenplay rights to the novel's sequel, stating that he “cannot in good conscience allow money to be wasted on a failure”.

Stan Lee filed and won a lawsuit after the producers of the movie Spider-Man did not give him a portion of the gross revenue.

The estate of Jim Garrison sued Warner Bros. for their share of the profits from the movie JFK, which was based on Garrison's book On the Trail of the Assassins.

Art Buckwald received a settlement after his lawsuit Buckwald v. Paramount over Paramount's use of Hollywood accounting. The court found Paramount's actions “unconscionable,” noting that it was impossible to believe that a movie (1988's Eddie Murphy comedy Coming to America) which grossed US$350 million failed to make a profit, especially since the actual production costs were less than a tenth of that. Paramount settled for an undisclosed sum, rather than have its accounting methods closely scrutinized.

The film My Big Fat Greek Wedding was considered hugely successful for an independent film, yet according to the studio, the film lost money. Accordingly, the cast (with the exception of Nia Varlos who had a separate deal) sued the studio for their part of the profits. The original producers of the film have sued Gold Circle Films due to Hollywood accounting practices because the studio have claimed the film lost $20 million.

According to his publisher's website, fantasy novelist Peter S. Beagle is owed a substantial amount of money by Granada Media International, the current owner of the animated movie based on Beagle's book The Last Unicorn. Beagle's contract entitles him to 5% of the net profits in the animated property, and 5% of the gross revenues from any film-related merchandising. Granada apparently claims the movie cost more to make than it took in, that it earned no money between 1986 and their acquisition of it in 1999, and the compounded interest on the loss adds up to several times what it cost to make. Beagle is currently attempting to raise sufficient funds to challenge Granada in court. Hollywood accounting is not limited to movies. An example is the Warner Bros. television series Babylon 5 created by J. Michael Straczynski. Straczynski, who wrote 90% of the episodes in addition to producing the show, would receive a generous cut of profits if not for Hollywood accounting.

The series, which was profitable in each of its five seasons from 1993-1998, has garnered more than US$1 billion for Warner Bros., most recently US$500 million in DVD sales alone. But in the last profit statement given to Straczynski, Warner Bros. claimed the property was $80 million in debt. “Basically,” says Straczynski, “by the terms of my contract, if a set on a WB movie burns down in Botswana, they can charge it against B5's profits.”

Peter Jackson, director of The Lord of the Rings, and his studio Wingnut Films, brought a lawsuit against New Line Cinema after “an audit . . . on part of the income of The Fellowship of the Ring.” Jackson stated this is regarding “certain accounting practices,” which may be a reference to Hollywood accounting. In response, New Line stated that their rights to a film of The Hobbit were time-limited, and since Jackson would not work with them again until the suit was settled, he would not be asked to direct The Hobbit, as had been anticipated. Fifteen actors are suing New Line Cinema claiming that they have never received their 5% of revenue from merchandise sold in relation to the movie, which contains their likeness. Similarly, the Tolkien estate has sued New Line, claiming that while their contract entitled them to 7.5% of the gross receipts, the film studio has refused to pay them any share of the $6 billion hit.

Due to the practice of Hollywood accounting the actual creators of intellectual property such as films, video games or literature, etc., are held hostage by the major media conglomerates and their Hollywood studios. Creators are not paid what they deserve and are often cheated out right, if they complain they are usually black balled in Hollywood which is a company town built on relationships. Because of the cartel (also called: trust a collusive international association of independent enterprises formed to monopolize production and distribution of a product or service, control prices, etc) like behavior of the major media conglomerates and their Hollywood studios creators do not get a fair return on their work.

A method and system for entertainment production financing using the Internet to sell “Participation Trust Units” alone or in groups that may be intermingled with other Participation Trust Units by an intermediary to the general public for a right to a payment that may or may not materialize based on the fact that in Hollywood most movies do not show any net profits is not a solution to the above mentioned problems.

Holders of Participation Trust Units do not have the right to audit any of the participating entertainment companies and none of the participating entertainment companies will have any accounting obligations to any holders of Participation Trust Units. Neither the financing entity nor any other holder of any contractual interest will have any copyright or ownership interest, or other property right, in any Output film underlying the contractual interest. Ergo, there is no ownership or equity in a media production company for the investor using this system. This system selling Participation Trust Units to the general public is geared to raising capital for slates of media productions involving the major studio/distributors. This above system does nothing to solve the problems affecting the independent entertainment media industry that has no access to the major studio/distributors or significant debt financing facilities such as banks In essence, this system is an extremely complex financial transaction that does not give any equity share of any media production company to the public investor and actually reinforces the Hollywood studio system which is the problem.

The prior art relating to a stock exchange type Hollywood trading system such as the Hollywood Stock Exchange, are online-games, based on the Hollywood studio system, that trade simulated stock in existing media and talent. This website has no bearing on real world finance for the production of entertainment media.

Using a story and an Internet website to raise capital can be and has been done previously. However, selling securities of a company thru any medium is tightly regulated by the SEC (Security and Exchange Commission) and State Blue Sky Laws (A blue sky law is a state law in the United States that regulates the offering and sale of securities to protect the public from fraud.) It is very difficult to do a Direct Public Offering (DPO) on the Internet because of the strict enforcement of U.S. Federal and State Laws and SEC regulations regarding the selling of stock to the public. Many companies have tried DPO's but found the impracticality of this method of raising capital because they cannot meet the government's high standards for selling stock.

Pre-selling advertising to raise funds for media productions is not an equity offering. Offering a promise of a future entitlement of some kind, namely a DVD of the movie after the funds have been raised and the production completed, is also regulated by U.S. Federal and State laws and SEC rules even though it is not a cash dividend or equity stock that can be traded on an exchange like the New York Stock Exchange (NYSE) or the NASDAQ (National Association of Securities Dealers Automated Quotations), as is the normal practice with SEC regulated stocks.

Asking for a contribution to produce entertainment content via the Internet with no financial remuneration to the contributor is a worthy act by an individual that would like to support the arts but is not a reasonable way to generate the extremely large amounts of capital necessary to professionally produce a movie or other professionally produced entertainment media products.

The prior art does not provide a solution to the problems discussed above and/or provide a robust or affordable way to overcome the problems of Hollywood accounting or making entertainment media and the distribution mediums more democratic or conform to the generally accepted accounting practices (GAAP). These methods will not change the way the Hollywood studio system operates.

References Cited

U.S. Patent Documents

| | | |
|---|---|---|
| 6,505,174 | Jan. 7, 2003 | Keiser |
| 6,792,411 | Sep. 14, 2004 | Massey |
| 7,062,457 | Jun. 13, 2006 | Kaufman |

Other References
Hollywood Stock Exchange, (www.hsx.com)
Stock Market 7e by Teweles, Copyright 1998-(Part Two-Work of the Stock Exchange) (pp.101-225) (Part Four-Regulations) (page.329-348)
Hollywood Wars by Cones, et al Copyright 2007 (page. 1-415).
The Insider's Guide To Film Finance by Alberstat, Copyright 2007-Chapter 10 (Alternative Financing) (page. 210-217).
43 Ways to Finance Your Feature Film by Cones et al Copyright 2008 (page.1-367).

### SUMMARY

My invention employs an Alternative Trading System and Electronic Communication Networks to issue and trade in entertainment companies IPO's (initial public offerings) and the secondary trading of these entertainment companies stocks that conform to the method of incorporating as a single product company.

A single product company is defined for this application as an entertainment media company whose corporate structure and bylaws for capital raising functions are designed to support the production, distribution and management of a single intellectual property that the stock IPO has been sold to produce. In this way the creators of a single product entertainment company and their stockholders only pay for what the project actually costs ergo, they will receive better financial returns on their investments than they would under the Hollywood accounting system that holds creators and stockholders hostage to a corrupt system.

In one of many examples; an entertainment corporation wants to raise capital to produce a major motion picture they decide to do an IPO for the company to raise enough capital to make, distribute and manage a single intellectual property. After the intellectual property is produced, distributed and revenue is made the profits of the corporation are distributed to the equity shareholders as dividends which they will continue to receive according to the bylaws of the corporation for as long as they own the stock in the company or the intellectual property's copyright is still effective.

The Copyright Term Extension Act (CTEA) of 1998 extended copyright terms in the United States by 20 years. Since the Copyright Act of 1976, copyright, would last for the life of the author plus 50 years, or 75 years for a work of corporate authorship. The Act extended these terms to life of the author plus 70 years and for works of corporate authorship to 120 years after creation or 95 years after publication, whichever endpoint is earlier. Copyright protection for works published prior to Jan. 1, 1978, was increased by 20 years to a total of 95 years from their publication date.

Ergo, buying shares of the IPO of an entertainment media company that uses the single product intellectual property formula of this application allows the shareholder to profit from their equity stock for the copyright life of the property or until they sell their shares in said company. This is a financial arrangement that is not available to stockholders of the major media conglomerates and their Hollywood studios or to the creators of the intellectual property.

My invention also enables a known value to be attached to the individual intellectual property established at its creation that will not be impacted by other products that a multi-product corporation would bundle together with the rest of its revenue from other products potentially diluting the value of the single intellectual property.

Employing the system of incorporating as a single intellectual property corporation the revenue and profit rests solely with said intellectual properties ability to be successful on its own merits for the copyright life of the product. This invention dramatically changes the way the Hollywood studio system compensates the product creators for their intellectual property and ends the practice of Hollywood accounting.

### BRIEF DESCRIPTION OF THE DRAWINGS

The flowchart depicts an entertainment media producer/creator developing an intellectual property that requires financing to produce, distribute and manage their single intellectual property.

The owner of the intellectual property decides to raise funds thru an initial public offering (IPO) by creating a single product entertainment media corporation whose structure and bylaws are designed to accomplish this end.

The initial public offering is listed on an alternative trading system (ATS).

The equity shares of said corporation are then able to be bought, sold and traded on the alternative trading system (ATS) thru electronic communication networks (ECN).

Once the single entertainment media corporation's equity shares are listed and purchased on the (ATS) the funds are used to produce, distribute and manage said property.

When the single product intellectual property corporation becomes profitable the corporation will distribute those profits as dividends to it's equity shareholders based on the corporate structure and bylaws of the corporation for the copyright life of the product.

### DETAILED DESCRIPTION OF THE INVENTION

The invention is a system and method for financing the production of intellectual property based on the producer/creators incorporating that property as a single intellectual property corporation by employing the proper corporate structure and bylaws to raise capital for a single product intellectual property corporation. By creating a single product entertainment media corporation, the project has a hereto unknown way to raise capital and distribute equity to shareholders.

As such the intellectual property is created by the producer/creator, who then decides to raise financial capital to produce the single intellectual property thru an initial public offering (IPO). The owner of the intellectual property who until this invention does not have any other way to finance their project can now do so by employing an IPO strategy for a single product corporation that is created by their corporate structure and bylaws with the intellectual property as collateral.

The initial public offering (IPO) is then listed on an alternative trading system (ATS) which is an SEC-approved non-exchange trading venues. They play an important role in public markets for allowing alternative means of accessing liquidity. Rule 300(a) of the United States security and exchange commission (SEC) regulation ATS provides the following legal definition of an “alternative trading system”: Any organization, association, person, group or persons or system: That constitutes, maintains or provides a market place or facilities for bringing together purchasers and sellers of securities or for otherwise performing with respect to securities the functions commonly performed by a stock exchange within the meaning of Rule 3b-16 of this chapter.

Equity shares of said intellectual property corporation are then bought sold and traded by those interested in the stock via electronic communication networks (ECN) as defined in rule 600(b) (23) of the (SEC) regulation NMS, are electronic trading systems that automatically match buy and sell orders at specified prices. ECN's register with the SEC as broker-dealers and are subject to regulation ATS.

The public buys the shares of the single product corporation which are listed on an alternative trading system (ATS) through the use of electronic communication networks (ECN) connected by computers and other digital devices. Once the project is profitable the company will distribute dividends based on the structure and bylaws of the corporation to the shareholder of that corporation from the intellectual properties profits.

An alternative but not the only other embodiment would be for the producer/creator wishing to produce their media project to do a multiple listing where the single product entertainment media project is created through corporate structures and bylaws to offer the original single product entertainment media corporation's IPO as a package of more than one intellectual property that would be derived from the first such as film sequels, television programs with multiple episodes or video games with scheduled upgrades.

Conclusions, Ramifications and Scope

The advantages of using this inventions method and system to raise capital for single product entertainment media companies are many fold but the main argument is to stop the practices of Hollywood accounting which is used to deprive creators, talent and stockholders out of their just equity payments will be eliminated for single product entertainment media corporations that produce media content as stated in this application. The single intellectual product corporation will only pay for what it requires to produce distribute and manage said property by employing Generally Acceptable Accounting Practices (GAAP) so that equity stake holders will receive what they are entitled to under the corporate structure and bylaws established at the inception of the project which eliminates the major media conglomerates hold and evasive cartel like practices on the creative community and equity shareholder values.

I claim:

1. A method and system for financing single product entertainment media corporations comprising:
a) a single intellectual property entertainment media product whose corporate structure and bylaws are designed to develop initial public offerings.
b) a method to sell single product entertainment media corporations initial public offerings through the use of an alternative trading system (ATS) to list their company's prospectus.
c) a electronic communication networks (ECN) using computers and other digital devices to buy, sell and trade the equity stock of single intellectual property entertainment media products.

2. A method and system for financing an intellectual property media corporation that takes into effect:
a) multiple variations of the single intellectual properties.
